(19) United States
(12) Patent Application Publication
(10) Pub. No.: US 2024/0397376 A1
(43) Pub. Date: Nov. 28, 2024

(54) SYSTEMS AND METHODS FOR TRAFFIC TRANSMISSION IN IAB NETWORK

(71) Applicant: ZTE Corporation, Shenzhen (CN)

(72) Inventors: Xueying DIAO, Shenzhen (CN); Ying HUANG, Shenzhen (CN); Lin CHEN, Shenzhen (CN)

(73) Assignee: ZTE Corporation, Shenzhen (CN)

(21) Appl. No.: 18/793,113

(22) Filed: Aug. 2, 2024

Related U.S. Application Data
(63) Continuation of application No. PCT/CN2022/075967, filed on Feb. 11, 2022.

(51) Int. Cl. H04W 28/02; H04W 28/086

(52) U.S. Cl. CPC H04W 28/0268; H04W 28/0289; H04W 28/0864

(57) ABSTRACT

Presented are systems and methods for traffic transmission in an integrated access and backhaul (IAB) network. A first network node can send a first message to a second network node. The first message can include information to manage the migration of traffic between a first topology managed by the first network node and a second topology managed by the second network node. A first network node can send a first message to an IAB-node. The first message can include information for re-routing of traffic.

### CROSS-REFERENCE TO RELATED APPLICATION

This application claims the benefit of priority under 35 U.S.C. § 120 as a continuation of International Patent Application No. PCT/CN2022/075967, filed on Feb. 11, 2022, the disclosure of which is incorporated herein by reference in its entirety.

### TECHNICAL FIELD

The disclosure relates generally to wireless communications, including but not limited to systems and methods for traffic transmission in an integrated access and backhaul (IAB) network.

### BACKGROUND

In the 5th Generation (5G) New Radio (NR) mobile networks, a user equipment (UE) can communicate with or access one or more nodes (e.g., access nodes) within a network. The UE can access the access node via a respective access link. At least one node among various access nodes may include a wired connection to a core network. The UE may connect directly to the node with a wired connection for fiber transport. The UE may connect and transmit data to an access node, where the access node can forward the data to a donor node via a wireless backhaul link. The donor node can include the wired connection to the core network for data communication.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A first network node can send a first message to a second network node. The first message can comprise information to manage the migration of traffic between a first topology managed by the first network node and a second topology managed by the second network node.

In some implementations, the first network node can comprise an F1-terminating donor, and the second network node may comprise a non-F1-terminating donor. In some implementations, the first message can include at least one of: a traffic index, to identify traffic offloaded to the second topology of the second network node, a traffic profile, to indicate quality-of-service (QOS) information for F1 user plane interface (F1-U) traffic or non-user-plane traffic type, an index of backhaul (BH) information, an index of a BH radio link control (RLC) channel established between an integrated access and backhaul (IAB) node and a parent node of the IAB node managed by the first or second network node, or between the IAB node and a child node of the IAB node, a routing index to identify a routing identifier (ID) of the offloaded traffic, the routing ID is allocated by the first network node, a number of BH RLC channels established between the IAB node and a parent node of the IAB node managed by the first or second network node, or between the IAB node and a child node of the IAB node, a number of routing IDs of the offloaded traffic, the routing IDs are allocated by the first network node, or a downlink (DL) transport network layer (TNL) address or DL IP prefix.

In some implementations, the first network node and the second network node can communicate a second message between each other to release or revoke traffic offloaded to the first topology of the first network node or the second topology of the second network node. The second message may comprise at least one of: a traffic index, an index of backhaul information or a routing index. In some implementations, the first network node can receive a third message from the second network node. The third message can include at least one of: a congestion indication, a desired buffer size for a backhaul (BH) radio link control (RLC) channel between an integrated access and backhaul (IAB) node and a parent node managed by the second network node, or a desired data rate associated with the BH RLC channel between the IAB node and the parent node managed by the second network node.

In some implementations, the first network node can send, either directly or indirectly, prior IP information of traffic offloaded to the second topology of the second network node to the second network node. The prior IP information can include at least one of: an index of an IP address, an IP address, that is allocated by the first network node, an IP usage, comprising one of: all traffic, F1 user plane interface (F1-U) traffic, F1 control plan interface (F1-C) traffic, or non-F1 traffic, or a backhaul adaptation protocol (BAP) address of the distributed unit (DU) of the first network node. In some implementations, the first network node can send an IP address request for each IP usage of an integrated access and backhaul (IAB) node to the second network node. The IP usage may include one of: all traffic, F1 user plane interface (F1-U) traffic, F1 control plan interface (F1-C) traffic, or non-F1 traffic, and the IP address request may include at least one of: number of requested IP addresses, or type of the requested IP addresses.

In some implementations, the second network node can allocate an IP address for the IAB node. In some cases, the first network node can receive information about the allocated IP address from the second network node. The information can comprise at least one of: an index of an IP address, an IP address, which is allocated by the first network node, the IP address, which is allocated by the second network node, an IP usage, comprising one of: all traffic, F1 user plane interface (F1-U) traffic, F1 control plan interface (F1-C) traffic, or non-F1 traffic, or a backhaul adaptation protocol (BAP) address of the distributed unit (DU) of the second network node.

In some implementations, the first network node can send backhaul information and the IP address allocated by the second network node to the IAB node. In certain aspects, the IAB node may receive information that comprises at least one of: an index of the IP address, an IP address, which is allocated by the first network node, an IP address, which is allocated by the second network node, an IP usage, comprising one of: all traffic, F1 user plane interface (F1-U) traffic, F1 control plan interface (F1-C) traffic, or non-F1 traffic, an indication to indicate that the received IP address allocated by the second network node is used for the traffic offloaded to a secondary cell group (SCG) path, the BAP address of the DU of the second network node, an identity of a topology or an ingress topology or an egress topology, a non-user-plane traffic type, at least one of: uplink (UL) user plane (UP) transport network layer (TNL) information or downlink (DL) UP TNL information, a UL source TNL address, or a DL destination TNL address.

In some implementations, the topology or the ingress topology or the egress topology can refer to the second topology of the second network node. In some cases, at least one of: the UL source TNL address can be used by the IAB node as a UL source IP address, or the DL destination TNL address can be used by the IAB node as a DL destination IP address.

At least one aspect is directed to a system, method, apparatus, or a computer-readable medium. A first network node can send a first message to an integrated access and backhaul (IAB) node. The first message can include information for re-routing of traffic.

In some implementations, the first message can include at least one of: a routing identifier (ID), a header rewriting configuration, an identity of a topology or an ingress topology or an egress topology, a BH Information for re-routing, or a BH information. In some implementations, the BH Information for re-routing or the BH information can include at least one of: a routing ID, a next-hop backhaul adaptation protocol (BAP) address, an egress backhaul (BH) radio link control (RLC) channel ID, or an identity of the topology or the ingress topology or the egress topology. In some cases, the routing ID can include a default routing ID.

In some cases, the header rewriting configuration can include at least one of: a prior routing ID of the packet, the routing ID of the packet, which is used for re-routing, an indication to indicate that the header rewriting configuration or a header rewriting entry is applied to a re-routing case, or an identity of a topology or an ingress topology or an egress topology. In some implementations, the topology or the ingress topology or the egress topology may refer to a topology of the first network node or the second network node.

In certain implementations, the first network node can include an F1-terminating donor or a non-F1-terminating donor. The first network node can send a second message to a second network node. The second message can include at least one of: a first routing ID, included when the packet is re-routed to a first topology of the first network node, a first indication to indicate that the first routing ID is used for the packet re-routed to the first topology of the first network node, a first traffic index, to identify re-routed traffic or traffic offloaded to the second topology of the second network node, a re-routing indicator, to indicate that traffic associated with the first traffic index may be re-routed to a second topology of the second network node, a traffic profile, to indicate quality-of-service (QOS) information for F1 user plane interface (F1-U) traffic or type of non-user-plane traffic type, an index of backhaul (BH) information, an index of a BH radio link control (RLC) channel established between the IAB node and a parent node of the IAB node managed by the first or second network node, or between the IAB node and a child node of the IAB node, a routing index to identify a routing identifier (ID) of re-routed traffic or traffic offloaded to the second topology of the second network node, the routing ID is allocated by the first network node, a number of BH RLC channels established between the IAB node and a parent node of the IAB node managed by the first or second network node, or between the IAB node and a child node of the IAB node, a number of routing IDs of re-routed traffic or traffic offloaded to the second topology of the second network node, the routing IDs are allocated by the first network node, a list of at least one of: potential IP addresses present in a source field of the re-routed packet to be transmitted from the second network node's distributed unit (DU) to the first network node's DU, or an identity of a tunnel.

In some cases, the first network node can send a third message to the second network node comprising at least one of: a second routing ID, included when the packet is re-routed to a second topology of the second network node, a second indication to indicate that the second routing ID is used for the packet re-routed to the second topology of the second network node, a second traffic Index, to identify the re-routed traffic or the traffic offloaded to the second topology of the second network node, a re-routing indicator, the list of the at least one of: the potential IP addresses present in the source field of the re-routed packet to be transmitted from the second network node's DU to the first network node's DU, or the identity of a tunnel. In some implementations, the first or second routing ID can include a default routing ID.

At least one aspect is directed to a system, method, apparatus, or a computer-readable medium. A second network node can receive a first message from a first network node. The first message can include information to manage the migration of traffic between a first topology managed by the first network node and a second topology managed by the second network node.

At least one aspect is directed to a system, method, apparatus, or a computer-readable medium. An integrated access and backhaul (IAB) node can receive a first message from a first network node. The first message can include information for re-routing of traffic.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example of a network deployed with integrated access and backhaul links, in accordance with some embodiments of the present disclosure; and

FIG. 4 illustrates a flow diagram of an example method for enabling inter-topology transport and inter-donor-DU re-routing, in accordance with an embodiment of the present disclosure.

### DETAILED DESCRIPTION

### 1. Mobile Communication Technology and Environment

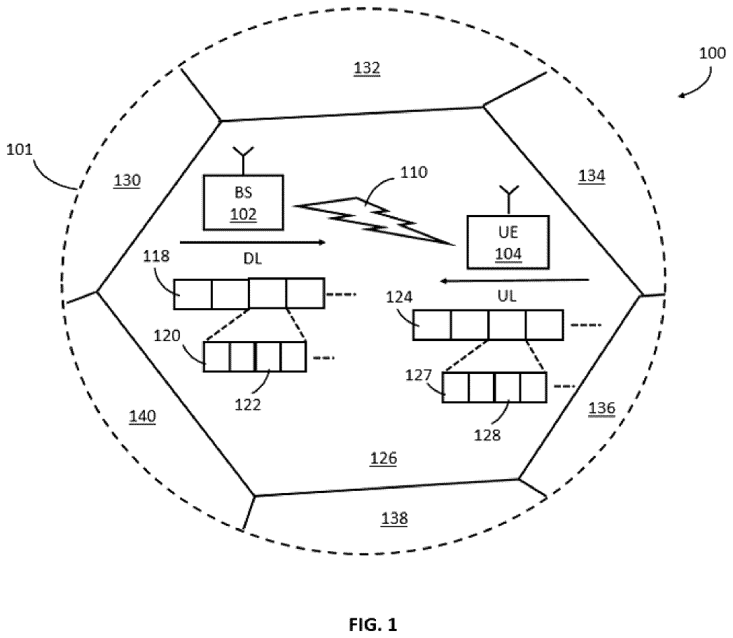

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

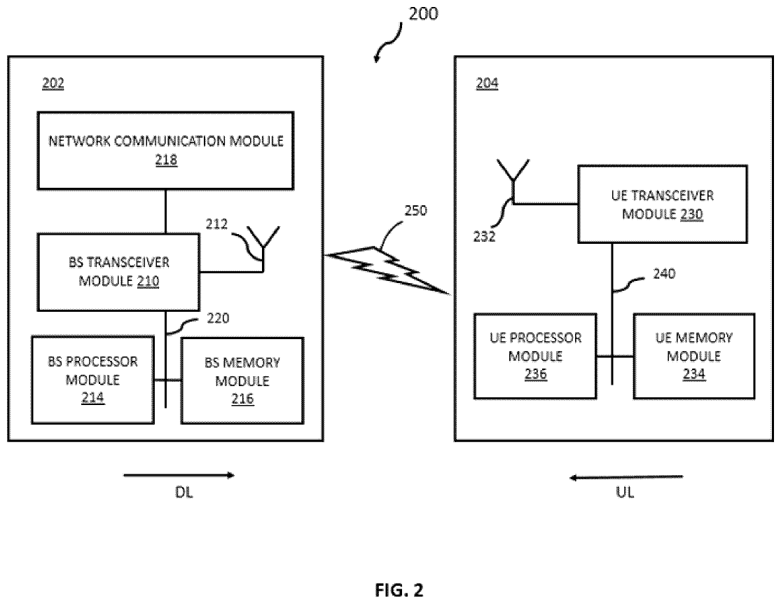

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (cNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bidirectional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Traffic Transmission in IAB Network

In certain systems (e.g., 5G new radio (NR), Next Generation (NG) systems, 3GPP systems, and/or other systems), such as in comparison to long-term evolution (LTE), NR may include/have a larger available bandwidth. The utilization of massive multiple-input/multiple-output (MIMO) and multi-beam facilitates and enables the research and application/integration/adoption of integrated access and backhaul links (IAB). The use of backhaul links and/or relay links can increase/enhance/improve the flexibility of dense NR cell networks deployment, without a need or requirement to increase the dense deployment of transmission networks.

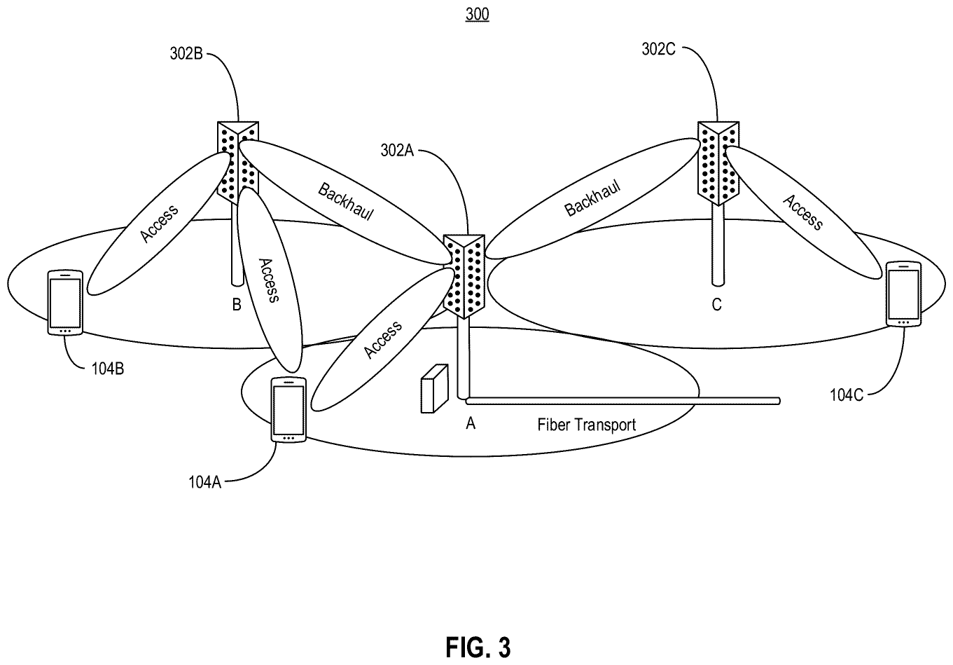

Referring to FIG. 3, depicted is an example of a network deployed with integrated access and backhaul links. In this example, three nodes 302 (e.g., access nodes accessed directly by one or more UEs 104), such as nodes A, B, and C (e.g., nodes 302A, 302B, and 302C), and three UEs 104 (e.g., UE 104A, UE 104B, and UE 104C) may be shown in FIG. 3. The nodes 302 may include or be referred to generally as a network node. In some cases, the nodes 302 can include or correspond to IAB nodes. Each node 302 may correspond to at least one of an access node (e.g., a node 302 providing access to the UE 104) and/or a donor node (e.g., another node with a wired connection, such as for fiber transport, communicative to the access node via backhaul link). In some cases, the access node may correspond to a donor node, such as if the UE 104 connects directly to a node with fiber transport. The nodes 302 may include one or more features or functionalities similar to the BS 102 (or BS 202), such as described in conjunction with FIGS. 1-2. Individual UEs 104 can access a respective node A, B, C through an access link. For instance, UE 104A can access node 302A, UE 104B can access node 302B, and UE 104C can access node 302C via a respective access link.

In this example, a wired connection may be provided/included/implemented between the access node A (e.g., node 302A) and a core network, and the access nodes B and C may not include or be implemented with a wired connection with the core network element. In this case, the access node that supports the wireless access of the UE 104 and/or transmits data/information wirelessly may include, correspond to, or be referred to as an IAB node. The access node providing the wireless backhaul feature/function for the IAB node, such that the UE 104 can connect to and/or communicate with the core network (e.g., via fiber transport), may be called/referred to as an IAB donor (e.g., sometimes referred to generally as donor node or network node). In this example, access node A may be a donor node providing access to the core network to one or more UEs 104 accessing access nodes A or B.

The UE 104 can transmit data between the access nodes (e.g., node B to node A or node C to node A) through the wireless backhaul link. For example, the access node B may provide/transmit/send the data/information received/obtained/acquired from the UE 104 to the access node A through a wireless backhaul link (e.g., a first wireless backhaul link). The access node A, responsive to receiving the data from the access node B, can send/transmit the UE data to the core network element via fiber transport or the wired connection. For the downlink, the core network element may send the UE data packet (e.g., response packet or downlink packet) to the access node A. The access node A may receive the UE data from the core network. Responsive to the reception, the access node A can transmit the UE data to the access node B coupled to the UE 104 via/through the wireless backhaul link. Accordingly, the access node B can provide/send/transmit the UE data through the access link to the respective UE 104.

However, in certain systems, wireless backhaul (BH) links/connections may be vulnerable/exposed to blockage, for instance, due to moving objects such as vehicles, seasonal changes (e.g., foliage, rain, snow, climate, etc.), or infrastructure changes (e.g., new buildings, landscape alteration, etc.). The systems and methods discussed herein can address the situations/scenarios of any blockage/disconnection of the BH links between IAB nodes. For example, an IAB-node (e.g., network node) can migrate/transfer/move to another IAB-donor (e.g., an IAB-donor connected to a core network) or perform/initiate radio resource control (RRC) re-establishment with another IAB-donor. Further, for IAB-nodes operating in a standalone (SA) mode, new radio (NR) dual connectivity (DC) can be used to enable/activate/perform route redundancy in the BH by allowing the IAB-mobile termination (MT) to have concurrent or multiple BH links with at least two parent nodes. The parent nodes may be connected/established to the same or to different IAB-donor-CUs. The one or more IAB-donor-CUs can control the establishment and/or release of redundant routes via the one or more parent nodes. In this example, inter-topology transport can be used/implemented/performed/executed/provided. The system and methods discussed herein can improve the information exchanged between IAB-donors to support inter-topology transport. Further, the systems and methods discussed herein can support inter-donor-DU re-routing, among other features or functionalities for re-routing communications between different IAB-nodes.

I. Implementation 1: Information Exchange Between F1-Terminating IAB Node and non-F1-Terminating IAB Node

In some implementations, a first network node (e.g., first IAB-donor or F1-terminating IAB-donor-CU) can communicate/send/exchange/transmit/provide/deliver a message or information to or with a second network node (e.g., second IAB-donor or non-F1-terminating IAB-donor-CU). The first network node and the second network node may be linked or connected to at least one IAB-node (e.g., a particular IAB-node connecting to two or more separated/split network nodes). The information exchanged between the first and second network nodes can facilitate/assist in managing the migration/transfer of an IAB node (e.g., boundary node and/or descendant node) traffic between the topologies managed by or associated with the two network nodes (e.g., migration from the first network node to the second network node or vice versa). The systems and methods can apply/implement one or more features, functionalities, operations, procedures discussed in this implementation for inter-donor partial migration, inter-donor radio link failure (RLF) recovery, inter-donor topology redundancy, among other inter-donor traffic transmission cases. In certain examples discussed herein, a network node may include or correspond to an IAB-donor connected to a core network. In some other examples, the IAB-node may include or correspond to an access node.

For example, an F1-terminating donor (e.g., a first network node) can send/transmit/provide an Xn application protocol (XnAP) message (e.g., a first message) to a non-F1 terminating donor (e.g., a second network node). The message can include at least one of: a traffic index, a traffic profile, an index of BH information, a list of BH information including at least one of a BH radio link control (RLC) channel index and/or a routing index, a number of BH RLC channels, a number of routing IDs of the offloaded traffic, and/or a downlink (DL) transport network layer (TNL) address or DL internet protocol (IP) prefix.

From the message, the non-F1 terminating donor can perform one or more operations based on the types of information. For example, the traffic index can be used to identify traffic offloaded to the topology of non-F1-terminating IAB-donor-CU (e.g., a second topology of the second network node). The traffic index can represent a certain traffic stream in a list shared between multiple IAB-nodes. The traffic profile can be used to indicate the traffic quality of service (QOS) parameters/requirements/information for F1 user plan interface (F1-U) traffic or non-user-plane (UP) traffic type. The index of the BH RLC channel can be used to identify a specific BH RLC channel established between boundary node (e.g., sometimes referred to generally as an IAB-node) and its parent node managed by a non-F1-terminating donor or an F1-terminating donor, and/or between boundary node and its child IAB-node managed by the non-F1-terminating donor. The routing index can be used to identify the routing identifier (ID) of the offloaded traffic. In this case, the routing ID can be allocated by the F1-terminating donor. The message can include an indication of the number of BH RLC channels established between the boundary node and its parent node managed by the non-F1-terminating donor or F1-terminating donor, and/or between the IAB node and its child node. The message can include the number of routing IDs of the offloaded traffic, where the routing IDs may be allocated by the F1-terminating donor.

Subsequent to the second network node receiving the first message, the first and second network nodes can communicate/exchange an XnAP message (e.g., a second message) between each other. In this case, the second message may be the same as the first message if sent from the F1-terminating donor to the non-F1-terminating donor. Otherwise, the second message may be different from the first message, such as sent from the non-F1-terminating donor to the F1-terminating donor. For example, the F1-terminating donor can send/transmit/provide the XnAP message to the non-F1-terminating donor to release or revoke offloaded traffic (e.g., traffic offloaded to the topology of the non-F1-terminating donor), and/or vice versa. The communications of the XnAP message between the two IAB-donors can occur concurrently or in any order. For instance, the first IAB-donor or the second IAB-donor can be the first to transmit the second message or communicate with each other concurrently. This XnAP message can include information of traffic to be released, such as at least one of: a traffic index, an index of backhaul information, or a routing index. The index can denote/identify/indicate one item in a list of items (e.g., a list of different traffic, a list of different BH information, etc.).

Further, a non-F1-terminating donor can send an XnAP message (e.g., a third message different from the first message and/or second message) to the F1-terminating donor. The third message can include at least one of: a congestion indication, a desired buffer size (e.g., in bytes) for a BH RLC channel between the boundary node (e.g., third IAB-node) and a parent node managed by the non-F1-terminating donor, and/or a desired data rate (e.g., in bytes) associated with the BH RLC channel between the boundary node and its parent node managed by the non-F1-terminating donor.

### II. Implementation 2: IP Address Allocation in Inter-Topology Transport/Migration

In some implementations, the systems and methods can improve IP address allocation in inter-topology transport/migration, such as discussed in the following example steps. As discussed herein, any reference to an IP address may include or refer to an IP prefix or an actual IP address, and vice versa.

Firstly, for example, an IP address allocation can be considered for a boundary node (e.g., described in at least the following four steps). As a first step of this example, the F1-terminating donor (e.g., a first network node) may include old/prior IP configuration/information of the offloaded traffic. The prior IP information can be included in an RRC message. The F1-terminating donor can send/transmit/provide the RRC message to non-F1-terminating donor (e.g., send to the BS 102 to forward to the non-F1-terminating donor). By using the RRC message, the F1-terminating donor can send the prior IP information to the non-F1-terminating donor indirectly (e.g., via the BS 102). Additionally or alternatively, the F1-terminating donor may send the prior IP configuration/information to the non-F1-terminating donor directly.

The prior IP configuration/information may include at least one of: an index of an IP address, an IP address/prefix allocated by the F1-terminating donor, an IP usage, and/or a backhaul adaptation protocol (BAP) address of the distributed unit (DU) of F1-terminating donor. The IP usage can include at least one of: all traffic, F1 user plane interface (F1-U) traffic, F1 control plan interface (F1-C) traffic, and/or non-F1 traffic.

In some implementations, or alternatively to the first step, the F1-terminating donor may send a separate IP address request to the non-F1-terminating donor for each IP usage of the boundary node (e.g., the IAB-node). In this case, the IP usage can include or define one of: all traffic, F1-U traffic, F1-C traffic, or non-F1 traffic. Further, each IP usage of IP address request can include at least one of: the number of requested IP address(es), and/or the type of requested IP address(es) (e.g., IPv4, IPv6/IPV6 prefix, among others).

As a second step of this example, after/subsequent to receiving/obtaining/acquiring the XnAP message including the prior IP information/configuration, the non-F1-terminating donor can allocate an IP address for the boundary node. In case IPsec tunnel mode is used to protect the F1 and non-F1 traffic, the IP address allocated by the non-F1-terminating donor can be the outer IP address. Accordingly, the non-F1-terminating donor may send/transmit the allocated IP address information (e.g., information about the allocated IP address) to the F1-terminating donor. This information may include at least one of: an IP address index, an IP address/prefix allocated by the F1-terminating donor, an IP address/prefix allocated by the non-F1-terminating donor, an IP usage, and/or a BAP address of the non-F1-terminating donor-DU. The IP address index can be the same as the IP address index sent by the F1-terminating donor to the non-F1-terminating donor. The IP usage can include one of: all traffic, F1-U traffic, F1-C traffic, or non-F1 traffic.

As a third step, after the F1-terminating donor receives the BH configuration/information of offloaded traffic from the non-F1-terminating donor (e.g., routing, BH RLC channel, bearer mapping configuration, and/or UL BH configuration), the F1-terminating donor can send/transmit/provide at least the received BH information and/or the IP address/prefix allocated by the non-F1-terminating donor to the boundary node. Accordingly, the boundary node can use the IP address/prefix for the offloaded traffic applying the specific/particular BH configuration.

For a fourth step, the boundary node (e.g., the IAB-node) can receive the IP address information allocated by the non-F1-terminating donor via an RRC message or an F1AP message (e.g., from a BS 102) from the F1-terminating donor. The RRC message may be generated by at least one of the F1-terminating donor or non-F1-terminating donor. The IP address information can include at least one of: IP address index (e.g., similar to the index that the F1-terminating donor sends to the non-F1-terminating donor), an IP address/prefix allocated by F1-terminating donor, an IP address/prefix allocated by the non-F1-terminating donor, the IP usage indicating or including at least one of: all traffic, F1-U traffic, F1-C traffic, and/or non-F1, an indication to indicate boundary node that the received IP address/prefix allocated by the non-F1-terminating donor is used for the traffic migrated/offloaded/transferred to the secondary cell group (SCG)-path, a BAP address of the non-F1-terminating donor-DU, an identity of a topology (e.g., referred to as “F1-terminating CU's topology” vs. “non-F1-terminating CU's topology”) (or an ingress topology or an egress topology) indicating boundary node that the received IP address/prefix is used for traffic transmitted in the topology indicated by the topology identity, non-UP traffic type, at least one of: UL UP TNL information and/or DL UP TNL information, an indication that the IP address allocated by the second network node is a DL destination IP address or a UL source IP address, a UL UP TNL address, and/or a DL UP TNL address.

Upon receiving the information (e.g., IP address information), the boundary node may determine/recognize or be configured not to replace the current IP address/prefix with the IP address allocated by the non-F1-terminating donor until the boundary node receives or identifies the specific traffic that is migrated to the SCG-path. In some cases, this step (e.g., fourth step) can be performed concurrent/parallel to the second step. In some other cases, the fourth step can be performed prior to or earlier than the second step.

Secondly, for example, an IP address allocation can be considered for at least one descendant node (e.g., a boundary node or any other IAB node). For a first step, the F1-terminating donor can request/indicate to the non-F1-terminating donor to allocate IP addresses/prefixes for a descendent node. In case IPsec tunnel mode is used to protect the F1 and non-F1 traffic, the IP address allocated by the non-F1-terminating donor can be the outer IP address. As a second step, after or responsive to receiving the IP addresses/prefixes for a descendent node, the F1-terminating donor can transmit/provide/send information to the descendant node via an F1AP message. This information sent to the descendant node can include at least one of: an IP address/prefix allocated by the non-F1-terminating donor, non-UP traffic type (e.g., UE-associated F1AP, non-UE-associated F1AP, and/or non-F1 traffic), UL UP TNL information, and/or DL UP TNL information, and/or an indication that the IP address/prefix is DL destination IP address/prefix or UL source IP address/prefix. The TNL information (e.g., UL UP TNL information and/or DL UP TNL information) may contain/include/comprise a transport layer address and a general packet radio service (GPRS) tunneling protocol (GTP) tunnel endpoint ID (GTP ID). The transport layer address can include or correspond to an IP address used for the F1 UP transport.

In some implementations, the F1-terminating donor can send/transmit IP address information to the IAB-node (e.g., a boundary node or a descendant node) via the F1AP message or RRC message. The IP address information can include at least one of: IP address information for UP traffic and/or IP address information for non-UP traffic. The IP address information for UP traffic can include at least one of: UL UP TNL information and/or DL UP TNL information, BH Information, an IP address/prefix allocated by the non-F1-terminating donor, an IP index, an indication indicating that the IP address/prefix is DL destination IP address/prefix or UL source IP address/prefix, a UL source TNL address, a DL destination TNL address, BAP address of the non-F1-terminating donor-DU, a topology identity which indicates the topology the BH information applies to or the IP address/prefix applies to, and/or an indicator which may indicate that the F1-U tunnel corresponding to the UL UP TNL Information or DL UP TNL information is to be migrated/offloaded/transferred, or indicate IAB-node that the IP address/prefix is associated with the BAP address of the non-F1-terminating donor-DU. The IP address information for non-UP traffic may be included in the UL BH non-UP traffic mapping. The IP address information for non-UP traffic can include at least one of: non-UP traffic type, BH Information, an IP address/prefix allocated by the non-F1-terminating donor, an IP index, an indication that the IP address/prefix is the DL destination IP address/prefix or UL source IP address/prefix, a UL source TNL address, a DL destination TNL address, BAP address of the non-F1-terminating donor-DU, a topology identity which indicates the topology the BH information applies to or the IP address/prefix applies to, and/or an indicator which may indicate that the non-UP traffic type is to be migrated/offloaded, or indicate that IAB-node that the IP address/prefix is associated with the BAP address of the non-F1-terminating donor-DU. The TNL information (e.g., UL UP TNL information and/or DL UP TNL information) may contain/include/comprise a transport layer address and a general packet radio service (GPRS) tunneling protocol (GTP) tunnel endpoint ID (GTP ID). In case IPsec tunnel mode is used to protect the F1 and non-F1 traffic, the IP address allocated by the non-F1-terminating donor can be the outer IP address.

### III. Implementation 3: Packets Re-routing Scheme

In some implementations, the F1-terminating donor (e.g., a first network node) and/or the non-F1-terminating donor (e.g., a second network node) may send/provide/indicate certain information to a boundary node for configuring re-routing of packet or traffic within the same topology or to a different topology. The re-routing can refer to an inter-donor-DU re-routing/migration/transfer (e.g, backup path), which can include at least three scenarios/situations/cases. A first scenario can include an intra-to-intra-topology re-routing. In this example, due to the egress link being unavailable or not available, the packet or traffic that is supposed to be routed within a specific topology can be re-routed to one or more other IAB-nodes within the same topology. A second scenario can include intra-to-inter-topology re-routing. In this example, due to the egress link not being available, the packet to be routed within the same topology can be re-routed to at least one other topology. A third scenario can include an inter-to-intra-topology re-routing. In this example, due to an unavailable egress link, the traffic to be routed within the same topology (e.g., inter-topology) can be re-routed to the initial topology. The initial topology may refer to a prior/previous topology, a first topology, etc.

The F1-terminating donor can send an XnAP message to the non-F1-terminating donor, including at least one of: a first routing ID used or include when the packet is re-routed to the topology of the F1-terminating donor, and/or an indication (e.g., a first indication) to indicate that the routing ID is used for the packet re-routed to the topology of the F1-terminating donor. This routing ID may be a default routing ID.

The F1-terminating donor can send an XnAP message to non-F1-terminating donor, including at least one of: a first traffic index used to identify the re-routed traffic or the traffic offloaded to the topology of the non-F1-terminating IAB-donor-CU, a re-routing indicator used to indicate that the traffic associated with the traffic index may be re-routed to the topology of the non-F1-terminating donor, a traffic profile used to indicate the traffic QoS parameters for F1-U traffic or non-UP traffic type, a list of potential IP prefixes and/or IP address(es) present/indicated/provided in the source field of the re-routed packets to be transmitted from the non-F1-terminating donor's donor-DU to the F1-terminating donor's donor-DU, tunnel ID which can correspond to an IP address and/or a tunnel endpoint identifier (TEID), a list of BH information (e.g., including a BH RLC channel index and/or a routing index), BH information for re-routing including at least one of a routing ID and/or a list of {Next-Hop BAP Address, Egress BH RLC Channel ID}, BH information including at least one of: a routing ID used in re-routing case, an identity of a topology or an ingress topology or an egress topology, a list of {Next-Hop BAP Address, Egress BH RLC Channel ID} used in re-routing case, and/or a list of {Next-Hop BAP Address, Egress BH RLC Channel ID, topology/ingress topology/egress topology identity}, The BH RLC channel index of the BH information can be used to identify a specific BH RLC channel established between the boundary node and its parent node managed by the F1-terminating donor, or between the boundary node and its child IAB-node. The routing index can be used to identify the routing ID of the offloaded traffic. In this example, the routing ID can be allocated by the F1-terminating donor.

Additionally or alternatively, the non-F1-terminating donor can send an XnAP message (e.g., different from the XnAP message sent by the F1-terminating donor to the non-F1-terminating donor) to the F1-terminating donor. This XnAP message can include at least one of: a second routing ID used when the packet is re-routed to the topology of the non-F1-terminating donor and/or an indication to indicate that the routing ID is used for the packet re-routed to the topology of the non-F1-terminating donor. This routing ID may be a default routing ID. The XnAP from the non-F1-terminating donor may further include at least one of: a second traffic index used to identify the re-routed traffic or the traffic offloaded to the topology of the non-F1-terminating IAB-donor-CU, and/or a re-routing indicator used to indicate that the traffic associated with the traffic index may be re-routed to the topology of the F1-terminating donor, a list of potential IP prefixes and/or IP address(es) present in the source field of the re-routed packets to be transmitted from F1-terminating donor's donor-DU to the non-F1-terminating donor's donor-DU, a tunnel ID which can correspond to an IP address and/or TEID, BH Information for re-routing including at least one of a routing ID and/or a list of {Next-Hop BAP Address, Egress BH RLC Channel ID}, and/or BH information including at least one of a routing ID used in a re-routing case, an identity of a topology or an ingress topology or an egress topology, a list of {Next-Hop BAP Address, Egress BH RLC Channel ID} used in re-routing case, and/or a list of {Next-Hop BAP Address, Egress BH RLC Channel ID, topology/ingress topology/egress topology identity}.

In case of re-routing, the IAB-donor-CU can send information or message to the IAB-node (e.g., boundary node) via F1AP message or RRC message (e.g., via a BS 102). In some cases, the IAB-donor-CU can send the information after or responsive to the first operation and/or the second operation (e.g., after the F1-terminating donor and/or non-F1-terminating donor transmits the XnAP message). In some other cases, this operation of the IAB-donor-CU sending the information can be performed independently (e.g., standalone, for intra-to-intra scenario). The information can include at least one of: a third (e.g., can be the first or the second) routing ID used when the packet is transmitted via the re-routed path, and/or an indication to indicate the IAB-node to use the third routing ID when performing re-routing. This routing ID (e.g., the third routing ID, which can be the first or the second routing ID) can be a default routing ID.

Further, this information may include, in addition to or as part of the above information listing, at least one of: a header rewriting configuration, a topology (e.g., referred to as “F1-terminating CU's topology” vs. “non-F1-terminating CU's topology”) identity, BH information for re-routing including a routing ID and/or a list of {Next-Hop BAP Address, Egress BH RLC Channel ID}, and/or BH Information including at least one of a routing ID used in the re-routing case, an identity of a topology or an ingress topology or an egress topology, a list of {Next-Hop BAP Address, Egress BH RLC Channel ID} used in the re-routing case, and/or a list of {Next-Hop BAP Address, Egress BH RLC Channel ID, topology/ingress topology/egress topology identity}. The header rewriting configuration can include at least one of: a previous/prior routing ID of the packet to be re-routed, a new/fourth routing ID of the packet used when the packet is transmitted via the re-routed path, an indication to indicate that the configuration (e.g., header rewriting configuration or header rewriting entry) is applied to a re-routing case/scenario, and/or information that allows the IAB-node (e.g., the boundary node) to determine either the egress topology, or the ingress topology, or the traffic direction (e.g., uplink or downlink) of a header-rewriting entry applying to, such as an identity of a topology or an ingress topology or an egress topology. The topology identity may indicate the IAB-node that the egress topology or ingress topology of the re-routed packet.

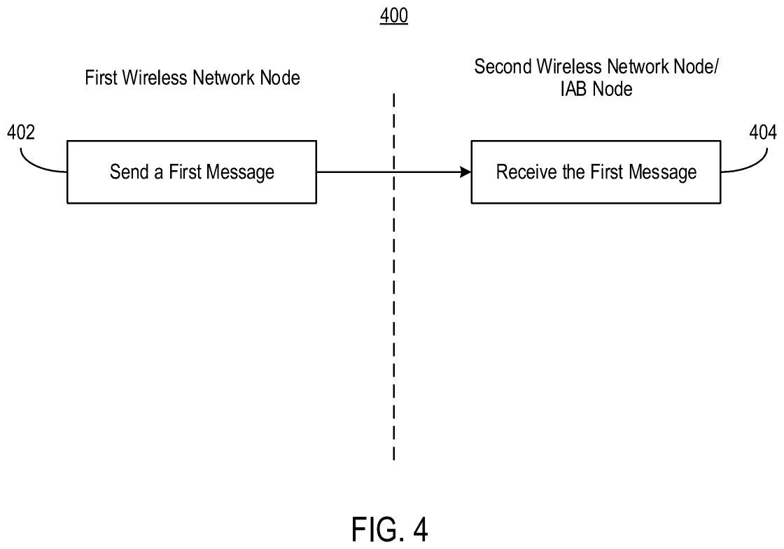

Referring to FIG. 4, depicted is an example of a flow diagram of an example method 400 for traffic transmission in the IAB node. As discussed herein, the IAB node of the example method 400 may include or correspond to a boundary node, among other types of nodes (e.g., IAB-nodes). The method 400 can be implemented using any of the components and devices detailed herein in conjunction with FIGS. 1-3. In overview, the method 400 can include sending a first message (402). The method 400 can include receiving the first message (404).

At operation (402), a first wireless network node (e.g., a first IAB-node or F1-terminating donor) can send/transmit/communicate/provide a first message (e.g., a first XnAP message) to a second wireless network node (e.g., a second IAB-node or non-F1 terminating donor). The first message can include at least information to manage the migration of traffic between a first topology managed by the first network node and a second topology managed by the second network node. At operation (404), in response to the transmission, the second network node can receive the first message from the first network node. The first network node may include or correspond to an F1-terminating donor, and the second network node can include or correspond to a non-F1-terminating donor. In this case, the transmission/communication of one or more messages between at least the first wireless network node and the second wireless network node can address or improve at least the BH information transmission and/or IP address allocation in inter-topology transport scenarios.

In some implementations, the first message can include at least one of: a traffic index, to identify traffic offloaded to the second topology of the second network node, a traffic profile, to indicate quality-of-service (QOS) information for F1 user plane interface (F1-U) traffic or non-user-plane traffic type, an index of backhaul (BH) information, an index of a BH radio link control (RLC) channel established between an IAB node (e.g., a boundary node) and a parent node of the IAB node managed by the first or second network node, or between the IAB node and a child node of the IAB node, a routing index to identify a routing ID of the offloaded traffic, the routing ID allocated by the first network node, a number of BH RLC channels established between the IAB node and a parent node of the IAB node managed by the second network node, or between the IAB node and a child node of the IAB node, a number of routing IDs of the offloaded traffic, the routing IDs allocated by the first network node, and/or a downlink (DL) transport network layer (TNL) address or DL IP prefix.

In certain examples, the first network node and the second network node can communicate/exchange a second message (e.g., bidirectional or transmitted in either direction) between each other to release or revoke traffic offloaded to the first topology of the first network node or the second topology of the second network node. For example, the second message may include at least one of: a traffic index, an index of backhaul information, and/or a routing index. The index, such as the traffic index, BH information index, and/or the routing index, can denote/identify/indicate/represent one item/component in a list of items (e.g., a list of different traffic or a list of different BH information). The communication of the second message can be subsequent to or in response to the transmission of the first message.

In further examples, the first network node can receive/obtain/acquire a third message from the second network node. The third message can be sent subsequent to the communication of the second message. The third message can include at least one of: a congestion indication, a desired buffer size for a BH RLC channel between an IAB node (e.g., boundary node) and a parent node managed by the second network node, and/or a desired data rate associated with the BH RLC channel between the IAB node and the parent node managed by the second network node.

In some implementations, for IP address allocation in inter-topology transport/migration, the first network node can send/transmit/provide, either directly or indirectly, prior/previous/old IP information of traffic or packet offloaded to the second topology of the second network node to the second network node. For example, a direct transmission may refer to transmitting the information via XnAP message (e.g., which may be the same as or different from the first message). In another example, an indirect transmission may refer to transmitting the information via an RRC message (e.g., to the base station (BS) for forwarding to the second network node). The prior IP information can include at least one of: an index of an IP address, an IP address, that is allocated by the first network node, an IP usage, comprising one of: all traffic, F1-U traffic, F1-C traffic, and/or non-F1 traffic, and/or a backhaul adaptation protocol (BAP) address of the DU of the first network node.

In some implementations, as an alternative to (or in addition to) the transmission of the prior IP information, the first network node can send an IP address request for each IP usage of an IAB node (e.g., boundary node) to the second network node. The IP usage may include one of: all traffic, F1-U traffic, F1-C traffic, or non-F1 traffic. The IP address request may include at least one of: a number of requested IP addresses, and/or the type of the requested IP addresses.

In further aspects, subsequent to or responsive to receiving the XnAP message (e.g., prior IP information/configuration or the IP address request, the second network node can allocate an IP address for the IAB node. After the allocation, the second network node can transmit the allocated IP address to the first network node, which the first network node can receive information about the allocated IP address from the second network node accordingly. This information can include at least one of: an index (e.g., can be the same as the index which the F1-terminating donor sends to the non-F1-terminating donor) of the IP address, an IP address, which is allocated by the first network node, the IP address, which is allocated by the second network node, an IP usage, including one of: all traffic, F1 user plane interface (F1-U) traffic, F1 control plan interface (F1-C) traffic, or non-F1 traffic, and/or a BAP address of the DU of the second network node.

In some implementations, the first network node can send BH information and the IP address allocated by the second network node to the IAB node. In certain aspects, the IAB node may receive information that include at least one of: the index of the IP address (e.g., can be the same index that the F1-terminating donor sends to non-F1-terminating donor), the IP address, which is allocated by the first network node, the IP address, which is allocated by the second network node, the IP usage including one of: all traffic, F1 user plane interface (F1-U) traffic, F1 control plan interface (F1-C) traffic, or non-F1 traffic, an indication to indicate that the received IP address allocated by the second network node is used for the traffic offloaded to a secondary cell group (SCG) path, the BAP address of the DU of the second network node, an identity of a topology or an ingress topology or an egress topology, non-user-plane traffic type, at least one of: UL UP transport network layer (TNL) information and/or downlink DL UP TNL information (e.g., the two TNL information may include a transport layer address and/or GTP-TEID), a UL source TNL address, and/or a DL destination TNL address.

In some implementations, the topology or the ingress topology or the egress topology can include, refer to, or correspond to the second topology of the second network node. In some cases, at least one of: the UL source TNL address can be used by the IAB node as a UL source IP address, and/or the DL destination TNL address can be used by the IAB node as a DL destination IP address.

In some alternative implementations, referring to operation (402), alternatively or additionally, the first wireless network node can send a first message (e.g., different from the first message sent from the first wireless network node to the second wireless network node) to the IAB node (e.g., boundary node). In this case, the first message can include information for re-routing of the traffic or packet(s). At operation (404) of this case, the IAB node can receive the first message from the first wireless network node in response to the transmission. In this case, the communication between at least the first wireless network node and the IAB node can improve or address the inter-donor-DU re-routing scenarios in the IAB network.

For example, the first message can include at least one of: a routing identifier (ID), a header rewriting configuration, an identity of a topology or an ingress topology or an egress topology, a BH Information for re-routing, and/or a BH information. In some implementations, the BH Information for re-routing and/or the BH information can include at least one of: a routing ID, a next-hop BAP address, an egress BH RLC channel ID, and/or an identity of the topology or the ingress topology or the egress topology. In some cases, the routing ID can include or correspond to a default routing ID.

The header rewriting configuration can include at least one of: a prior routing ID of the packet, the routing ID of the packet, which is used for re-routing, an indication to indicate that the header rewriting configuration or a header rewriting entry is applied to a re-routing case, and/or an identity of a topology or an ingress topology or an egress topology. In some implementations, the topology or the ingress topology or the egress topology may refer to or include a topology of the first network node or the second network node

In certain implementations, the first network node can include or correspond to one of an F1-terminating donor or a non-F1-terminating donor. The first network node can send a second message to a second network node, which can include a non-F1-terminating donor or an F1-terminating donor, respective of the first network node. Based on whether the first network node is F1-terminating donor or non-F1-terminating donor, as discussed above, the second message can include at least one of: a first routing ID (e.g., applies to intra-to-inter-topology re-routing), included when the packet is re-routed to a first topology of the first network node, a first indication to indicate that the first routing ID is used for the packet re-routed to the first topology of the first network node, a first traffic index, to identify re-routed traffic or traffic offloaded to the second topology of the second network node, a re-routing indicator, to indicate that traffic associated with the first traffic index may be re-routed to a second topology of the second network node, a traffic profile, to indicate QoS information for F1-U traffic or type of non-user-plane traffic type, an index of BH information, an index of a BH RLC channel established between the IAB node and a parent node of the IAB node managed by the second network node, or between the IAB node and a child node of the IAB node, a routing index to identify a routing ID of re-routed traffic or traffic offloaded to the second topology of the second network node, the routing ID allocated by the first network node, a number of BH RLC channels established between the IAB node and a parent node of the IAB node managed by the second network node, or between the IAB node and a child node of the IAB node, a number of routing IDs of re-routed traffic or traffic offloaded to the second topology of the second network node, the routing IDs allocated by the first network node, a list of at least one of: potential IP addresses present in a source field of the re-routed packet to be transmitted from the second network node's DU to the first network node's DU, and/or an identity of a tunnel, that comprises at least one of: an IP address and/or a tunnel endpoint identifier (TEID). This list and tunnel ID can apply to intra-to-inter-topology re-routing and inter-to-intra-topology re-routing.

In further aspects of the implementations, the first network node can send a third message to the second network node. The transmission of the third message may be subsequent to the transmission of the second message. The third message can include at least one of: a second routing ID (e.g., applied to intra-to-inter-topology re-routing), included when the packet is re-routed to a second topology of the second network node, a second indication to indicate that the second routing ID is used for the packet re-routed to the second topology of the second network node, a second traffic Index, to identify the re-routed traffic or the traffic offloaded to the second topology of the second network node, the re-routing indicator, the list of the at least one of: the potential IP addresses present in the source field of the re-routed packet to be transmitted from the second network node's DU to the first network node's DU, and/or the identity of a tunnel. At least the second traffic index and/or the re-routing indicator of the third message can be applied to inter-to-intra-topology re-routing scenario. Further, at least the list and/or the tunnel ID of the third message can be applied to both intra-to-inter-topology re-routing and/or inter-to-intra-topology re-routing scenarios. In some implementations, the first or second routing ID can include a default routing ID.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A method, comprising:
sending, by a first network node to a second network node, a first message,
wherein the first message comprises information to manage migration of traffic between a first topology managed by the first network node and a second topology managed by the second network node.

2. The method of claim 1, wherein the first network node comprises an F1-terminating donor, and the second network node comprises a non-F1-terminating donor.

3. The method of claim 1, wherein the first message comprises at least one of:
a traffic index, to identify traffic offloaded to the second topology of the second network node,
a traffic profile, to indicate quality-of-service (QOS) information for F1 user plane interface (F1-U) traffic or non-user-plane traffic type,
an index of backhaul (BH) information,
an index of a BH radio link control (RLC) channel established between an integrated access and backhaul (IAB) node and a parent node of the IAB node managed by the first or second network node, or between the IAB node and a child node of the IAB node,
a routing index to identify a routing identifier (ID) of the offloaded traffic, the routing ID is allocated by the first network node,
a number of BH RLC channels established between the IAB node and a parent node of the IAB node managed by the first or second network node, or between the IAB node and a child node of the IAB node,
a number of routing IDs of the offloaded traffic, the routing IDs are allocated by the first network node, or
a downlink (DL) transport network layer (TNL) address or DL IP prefix.

4. The method of claim 1, comprising:
communicating, between the first network node and the second network node, a second message to release or revoke traffic offloaded to the first topology of the first network node or the second topology of the second network node,
wherein the second message comprises at least one of: a traffic index, an index of backhaul information or a routing index.

5. The method of claim 1, comprising:
receiving, by the first network node from the second network node, a third message comprising at least one of:
a congestion indication,
a desired buffer size for a backhaul (BH) radio link control (RLC) channel between an integrated access and backhaul (IAB) node and a parent node managed by the second network node, or
a desired data rate associated with the BH RLC channel between the IAB node and the parent node managed by the second network node.

6. The method of claim 1, comprising:
sending, by the first network node to the second network node, either directly or indirectly, prior IP information of traffic offloaded to the second topology of the second network node, the prior IP information comprising at least one of:
an index of an IP address,
an IP address, that is allocated by the first network node,
an IP usage, comprising one of: all traffic, F1 user plane interface (F1-U) traffic, F1 control plan interface (F1-C) traffic, or non-F1 traffic, or
a backhaul adaptation protocol (BAP) address of the distributed unit (DU) of the first network node.

7. The method of claim 1, comprising:
sending, by the first network node to the second network node, an IP address request for each IP usage of an integrated access and backhaul (IAB) node,
wherein the IP usage comprising one of: all traffic, F1 user plane interface (F1-U) traffic, F1 control plan interface (F1-C) traffic, or non-F1 traffic, and the IP address request includes at least one of: number of requested IP addresses, or type of the requested IP addresses.

8. The method of claim 6, wherein the second network node allocates an IP address for the IAB node.

9. The method of claim 8, comprising:
receiving, by the first network node from the second network node, information about the allocated IP address, which comprises at least one of:
an index of an IP address,
an IP address, which is allocated by the first network node,
the IP address, which is allocated by the second network node,
an IP usage, comprising one of: all traffic, F1 user plane interface (F1-U) traffic, F1 control plan interface (F1-C) traffic, or non-F1 traffic, or
a backhaul adaptation protocol (BAP) address of the distributed unit (DU) of the second network node.

10. The method of claim 9, comprising:
sending, by the first network node, backhaul information and/or the IP address allocated by the second network node, to the IAB node.

11. The method of claim 8, wherein the IAB node receives information that comprises at least one of:
an index of an IP address,
an IP address, which is allocated by the first network node,
an IP address, which is allocated by the second network node,
an IP usage, comprising one of: all traffic, F1 user plane interface (F1-U) traffic, F1 control plan interface (F1-C) traffic, or non-F1 traffic,
an indication to indicate that the received IP address allocated by the second network node is used for the traffic offloaded to a secondary cell group (SCG) path,
the BAP address of the DU of the second network node,
an identity of a topology or an ingress topology or an egress topology,
a non-user-plane traffic type,
at least one of: uplink (UL) user plane (UP) transport network layer (TNL) information or downlink (DL) UP TNL information,
a UL source TNL address, or
a DL destination TNL address.

12. The method of claim 11, wherein the topology or the ingress topology or the egress topology refers to the second topology of the second network node.

13. The method of claim 11, wherein at least one of:
the UL source TNL address is used by the IAB node as a UL source IP address, or
the DL destination TNL address is used by the IAB node as a DL destination IP address.

14. A method, comprising:
receiving, by a second network node from a first network node, a first message,
wherein the first message comprises information to manage migration of traffic between a first topology managed by the first network node and a second topology managed by the second network node.

15. A second network node, comprising:
at least one processor configured to:
receive, via a receiver from a first network node, a first message,
wherein the first message comprises information to manage migration of traffic between a first topology managed by the first network node and a second topology managed by the second network node.

16. A first network node, comprising:
at least one processor configured to:
send, via a transceiver to a second network node, a first message,
wherein the first message comprises information to manage migration of traffic between a first topology managed by the first network node and a second topology managed by the second network node.

17. The first network node of claim 16, wherein the first network node comprises an F1-terminating donor, and the second network node comprises a non-F1-terminating donor.

18. The first network node of claim 16, wherein the first message comprises at least one of:
a traffic index, to identify traffic offloaded to the second topology of the second network node,
a traffic profile, to indicate quality-of-service (QOS) information for F1 user plane interface (F1-U) traffic or non-user-plane traffic type,
an index of backhaul (BH) information,
an index of a BH radio link control (RLC) channel established between an integrated access and backhaul (IAB) node and a parent node of the IAB node managed by the first or second network node, or between the IAB node and a child node of the IAB node,
a routing index to identify a routing identifier (ID) of the offloaded traffic, the routing ID is allocated by the first network node,
a number of BH RLC channels established between the IAB node and a parent node of the IAB node managed by the first or second network node, or between the IAB node and a child node of the IAB node,
a number of routing IDs of the offloaded traffic, the routing IDs are allocated by the first network node, or
a downlink (DL) transport network layer (TNL) address or DL IP prefix.

19. The first network node of claim 16, wherein the at least one processor is configured to:
communicate, using the transceiver, between the first network node and the second network node, a second message to release or revoke traffic offloaded to the first topology of the first network node or the second topology of the second network node,
wherein the second message comprises at least one of: a traffic index, an index of backhaul information or a routing index.

20. The first network node of claim 16, wherein the at least one processor is configured to:
receive, via the transceiver from the second network node, a third message comprising at least one of:
a congestion indication,
a desired buffer size for a backhaul (BH) radio link control (RLC) channel between an integrated access and backhaul (IAB) node and a parent node managed by the second network node, or
a desired data rate associated with the BH RLC channel between the IAB node and the parent node managed by the second network node.
